(19) United States
(12) Patent Application Publication
(10) Pub. No.: US 2012/0104009 A1
(43) Pub. Date: May 3, 2012

(54) BIODEGRADABLE BUBBLE-SHAPED WRAP AND VOID FILL BRACES

(75) Inventor: Carlo Fascio, Maple (CA)

(73) Assignees: GLOBAL PATENTED TECHNOLOGIES INC., Toronto, ON (CA); ENVIROPAC SOLUTIONS INC., Toronto, ON (CA)

(21) Appl. No.: 13/380,410

(22) PCT Filed: Jun. 22, 2010
(86) PCT No.: PCT/CA2010/000950

§ 371 Date: Dec. 22, 2011

(30) Foreign Application Priority Data
Jun. 22, 2009 (CA) 2,670,217

(51) Int. Cl. B65D 25/00; B32B 3/12; B29C 43/34

(52) U.S. Cl. 220/694; 156/245; 264/328.1; 428/178

(57) ABSTRACT

This invention provides packaging material made from starch and cellulose fiber obtained from recycled paper waste. The process involves drawing a suspension of pulp and starch in water into a mold, and withdrawing water from the suspension while in the mold. Bubble-shaped wrap and bracing made according to the invention are designed for use as cushioning for the shipment of fragile or irregularly shaped items. The packaging is biodegradable when exposed to water in the environment.

### TECHNICAL FIELD

This invention provides a molded pulp fiber bubble-shaped wrap and a void-fill brace derived from 100% post consumer paper waste. The wrap and the brace can be used as cushioning devices for the shipment of fragile or irregularly shaped items.

### BACKGROUND

Plastic bubble sheeting made of high-density polyethylene (HDPE) is a pliable plastic material commonly used for packing fragile items. Regularly spaced, protruding air-filled hemispheres (“bubbles”) of about 6 to 26 mm in diameter sizes provide cushioning for precious or breakable items. Multiple layers can be used to provide shock and vibration isolation. A single layer can be used as a surface protective layer.

Bubble Wrap® was created by two engineers, Alfred Fielding and Marc Chavannes, in 1957. The term is a registered trademark of Sealed Air Corporation, Elmwood Park N.J. Bubble Wrap and other products are sold by packaging supply companies, such as U-line® Shipping Supplies, Chicago Ill.; Geami, Morrisville N.C.; Robins Paper Bag Co. Ltd., Canterbury, Kent, UK; Nobisco Ltd, Birmingham, UK; PilloPak B.V., Eerbeek, Netherlands; Wholesale Packaging Ltd., Toronto, Canada; Doverco Inc, Montreal, Canada; and Lion Shipping Supplies Canada Inc., Mississauga, Canada.

It is not always possible to ship items in containers that are custom made for their design and shape. Where items are shipped in a larger box, it may be necessary to fill voids to prevent shifting or breakage during transit. Typical void-fill products, like so-called packaging peanuts, take up as much volume before and after shipping as they do in the shipping container. This is an inconvenience to both the shipper and the package recipient.

However, in spite of the wide-spread use of HDPE bubble wrap and Styrofoam® void-fill for packaging, these materials are not easily recyclable according to current technology. Discarded packaging generates a good deal of waste material and adds to landfill. Clearly, there is a need for a less expensive packaging material that is environmentally friendly and 100% biodegradable.

### DRAWINGS

FIG. 1 is a drawing of a prototype fiber bubble of this invention. Top left panel is the top view; top right panel is the side view; lower panel is the bottom view.

FIG. 2 shows another prototype fiber bubble, having a roughly hemisphere design with solid round support structures on the sides and up the middle.

FIG. 3 shows five other designs for the bubbles.

FIG. 4 shows square bubble shapes packed in an array as they would come from the production line.

FIG. 5 shows the manufacturing process for the bubble shaped wrapping. Pulp is drawn into the mold by a vacuum, and then expelled as the drum rotates to the top, whereupon it is glued to the paper backing.

FIG. 6 shows actual fiber bubbles formed according to the manufacturing method.

FIG. 7 shows biodegradable stackable bracing for use in packaging for void fill. It stacks tightly for distribution and storage, but separates into units that collectively occupy a much larger volume when the alternating corrugations are no longer aligned.

### DESCRIPTION

This invention provides packing material suitable for wrapping and protecting packaged items. A bubble shaped wrap is provided, which can be used in the same manner as conventional bubble wrap. A brace with alternating corrugations is provided, which can be used to fill voids in shipping containers.

The materials of this invention constitute a substantial advance, by virtue of the fact that they are efficiently biodegradable and environmentally compatible. In particular, the bubble shaped wrap and the braces are made as a combination of fiber and starch by a simple and inexpensive process, placing into the hands of the reader a more environmentally friendly standard for use in the packaging industry.

### Starting Materials

The cellulose fiber and starch used to make the bubble shaped wrap of this invention can be obtained from various sources.

Suitable fibers for the fiber content include polymers of man-made fiber, such as polyamide nylon, polyesters, phenol-formaldehyde, polyvinyl alcohol fiber, polyvinyl chloride fiber, polyolefins, acrylic fiber, carbon fibers, polyurethane and other resin-based fibers. Cellulose fiber is preferred, being the natural structural component of the primary cell wall and connective tissue of green plants. About 33 percent of all plant matter is cellulose. For industrial use, cellulose can be obtained from wood pulp and cotton (the cellulose content of cotton is 90 percent and that of wood is 50 percent).

In particular, cellulose fiber is provided as a starting ingredient for the materials of this invention as pulp. This refers to fibrous material prepared by chemically or mechanically separating fibers from wood or fiber crops. Included are mechanical pulp, chemithermomechanical pulp, chemical pulp made by the Kraft process or by sulfite processing, and pulp recycled from industrial and consumer waste.

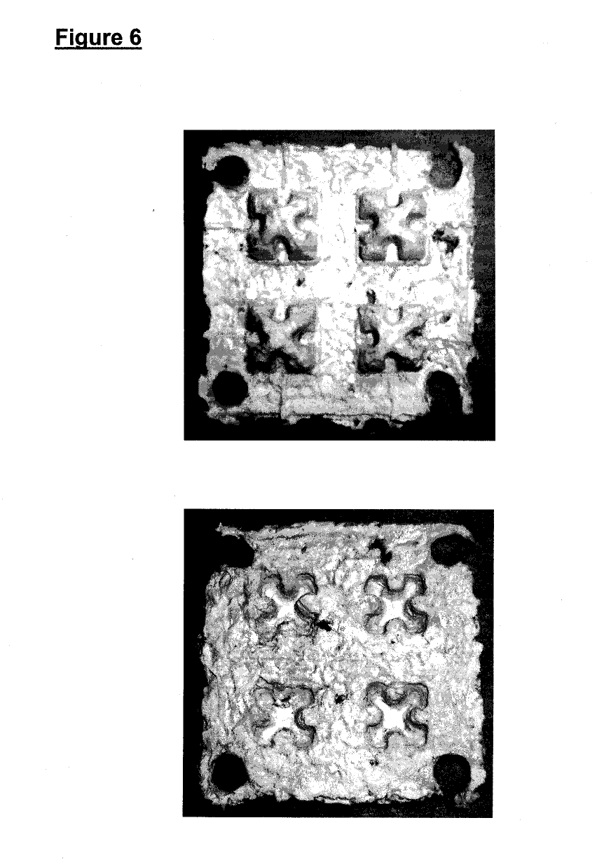

The source material of the pulp used for the bubble shaped wrap shown in FIG. 6 was made from recycled paper by beating in warm water bath, and then dispersing the fibers using a blender.

Starch is a polysaccharide carbohydrate consisting of glucose monomers joined together by glycosidic bonds. Starch is produced by all green plants as an energy store. Pure starch is a white, and consists of linear amylose, helical amylose, branched amylopectin, or any of these in combination. Depending on the plant source, starch generally contains 20 to 25% amylose and 75 to 80% amylopectin. Each plant species has a unique starch granular size: rice starch is relatively small (about 2 μm), potato starch have larger granules (up to 100 μm).

A suitable source of starch for use in this invention is industrial corn starch. This can be obtained from National Starch and Chemical Company (NACAN), Brampton, Ontario, now owned by Akzo Nobel N.V. They provide wet-end starch additives to improve strength and productivity in acid, neutral or alkaline paper and board production, and surface starch strength and printability additives for paper and board, such as uncoated office papers, food packaging papers and uncoated book papers.

Some modified starches can also be used. The following list of modified starches is classified by the system established by the International Numbering System for Food Additives (INS):
1401 Acid-treated starch
1402 Alkaline-treated starch
1403 Bleached starch
1404 Oxidized starch
1405 Starches, enzyme-treated
1410 Monostarch phosphate
1411 Distarch glycerol
1412 Distarch phosphate esterified with sodium trimetaphosphate
1413 Phosphated distarch phosphate
1414 Acetylated distarch phosphate
1420 Starch acetate esterified with acetic anhydride
1421 Starch acetate esterified with vinyl acetate
1422 Acetylated distarch adipate
1423 Acetylated distarch glycerol
1440 Hydroxypropyl starch
1442 Hydroxypropyl distarch phosphate
1443 Hydroxypropyl distarch glycerol
1450 Starch sodium octenyl succinate

Other materials can be used in the pulp slurry or during the process as desired: for example, one or more surfactants, strengtheners, binders, dispersants, pro- or anti-microbials, and so on. However, such ingredients are usually not necessary, in which case they can be left out to promote the pro-environmental profile of the product.

### Manufacture of Bubble-Shaped Wrap

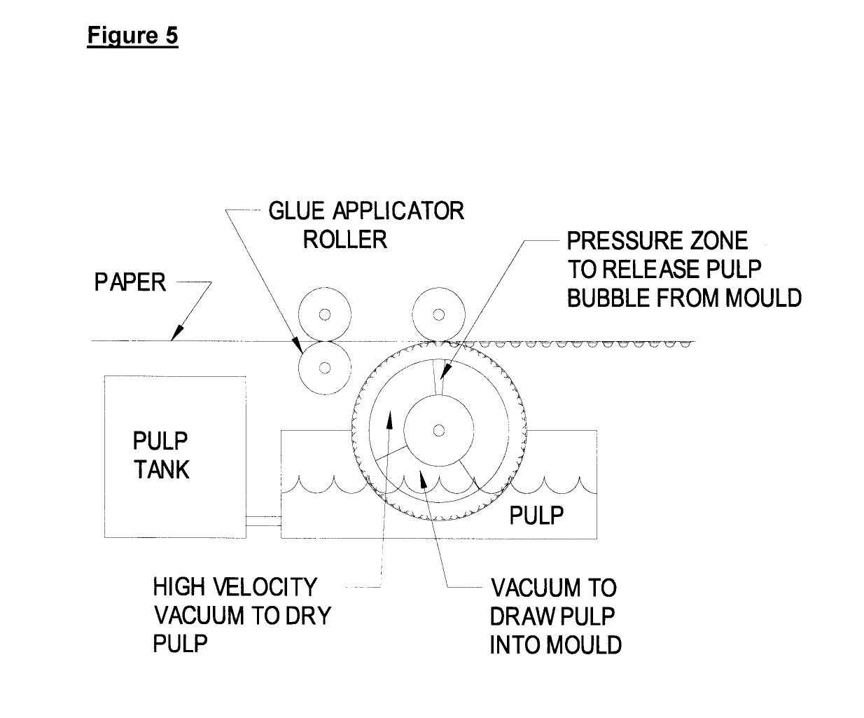

FIG. 5 depicts the process by which the bubble shaped wrap of this invention may be manufactured. A suspension or slurry of cellulose or other fiber and starch is first prepared in a liquid medium (usually water) at a ratio of between about 2:1 and 10:1, depending on the hardness and degradability desired, typically about 3:1. The slurry is placed in a bath, and is drawn into a mold having the outer shape of the bubble.

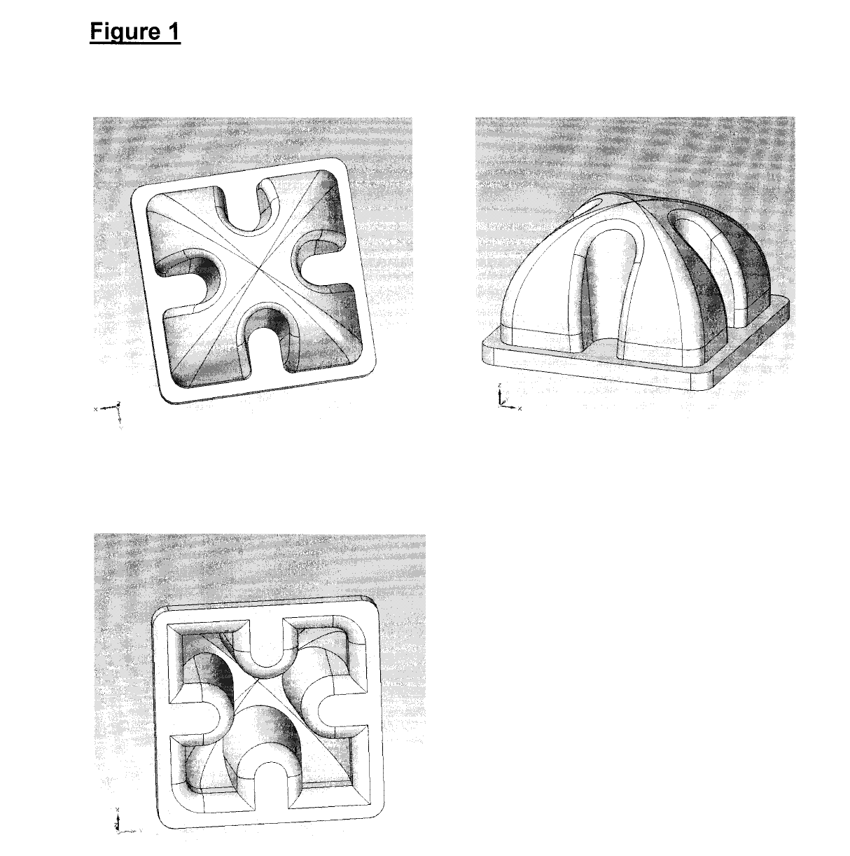

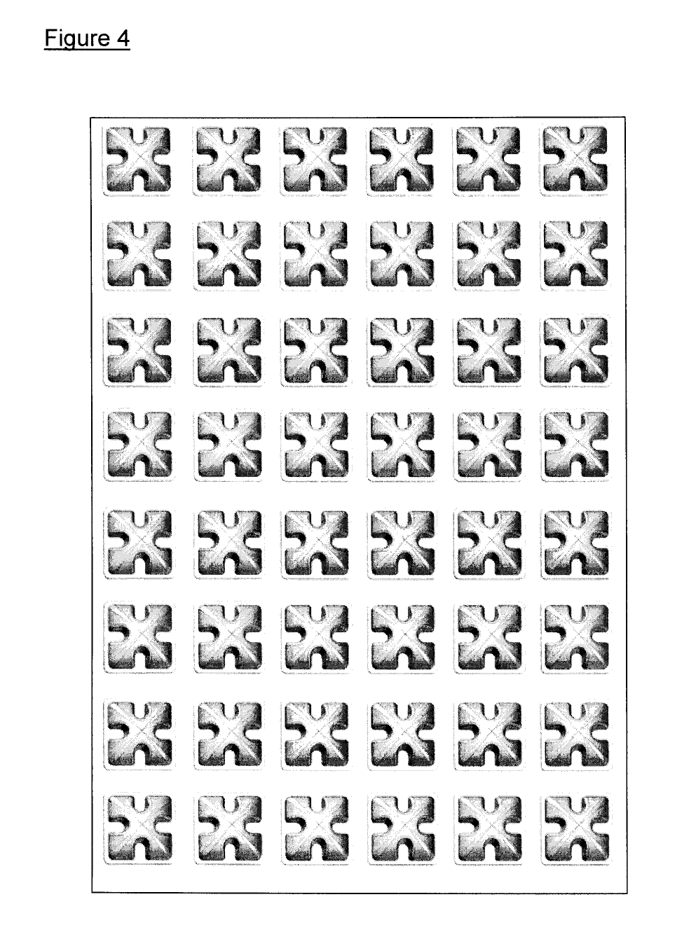

FIG. 1 shows the shape of the bubbles used in a working example of this invention. The bubbles are domed shaped, and are substantially square. Supporting the dome are arches running between the diagonal corners. There is also support provided by the four circular indentations, one on each side. An advantage of the square shape is that it allows close packing of bubbles within a sheet, as depicted in FIG. 4.

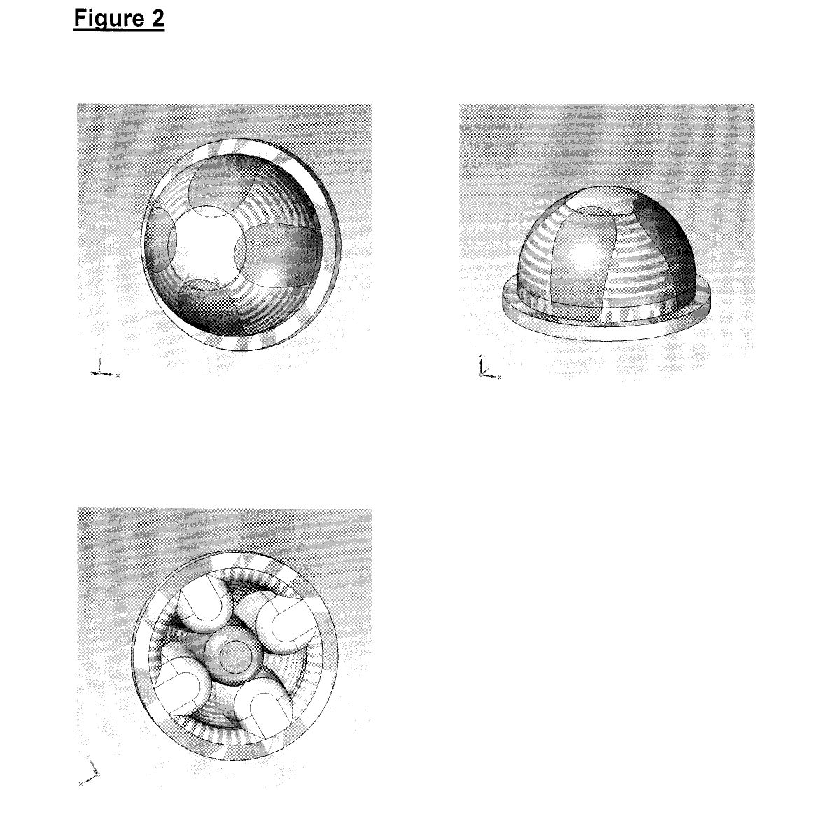

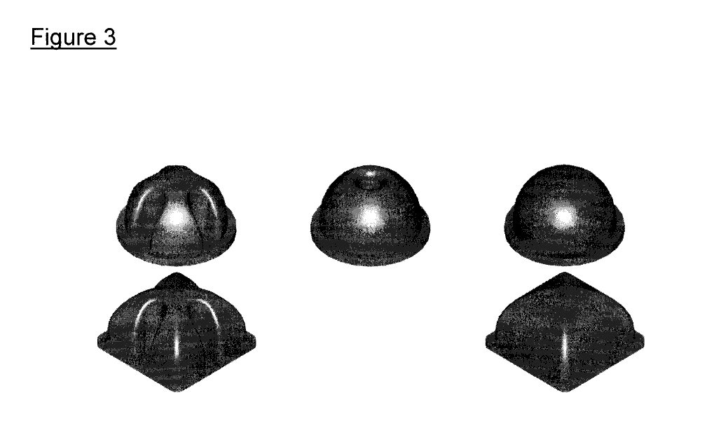

FIG. 2 shows another bubble design suitable for use in this invention. Here, the domed structures are round and have five solid supports supporting each dome: one in the center, and the others equally spaced around the circumference. FIG. 3 shows five other bubble designs that can be used either instead, or in combination with either or both of the foregoing shapes. The bubbles may be solid in their interior, but more usually are thin-walled, allowing an air-space between the bubble shell and the backing.

Once the slurry is drawn into the mold, the vacuum is allowed to continue until essentially all of the water has been removed. The pressure is then reversed, causing the bubbles to be expelled from the mold. Samples of the bubbles formed in this way are shown in FIG. 6. The bubbles are then usually adhered onto a suitable backing of biodegradable material, typically made of paper. The glue applied to the side of the paper where the bubbles are placed is chosen to be environmentally friendly, exemplified by starch- or milk-based glue.

The cushioning properties, flexibility and the day-to-day durability of the bubble-shaped wrap of this invention can be adjusted to suit the purpose that the user may have in mind by altering the ratio of fiber to starch, by changing the plant source of the starch to one having different properties, and by making adjustments to the various components. The design of the bubble, the thickness of the wall, the nature of the support structures, and the composition of the slurry are chosen so that the bubbles resist crushing but provide the desired degree of cushioning.

### Manufacture of Void-Fill Braces

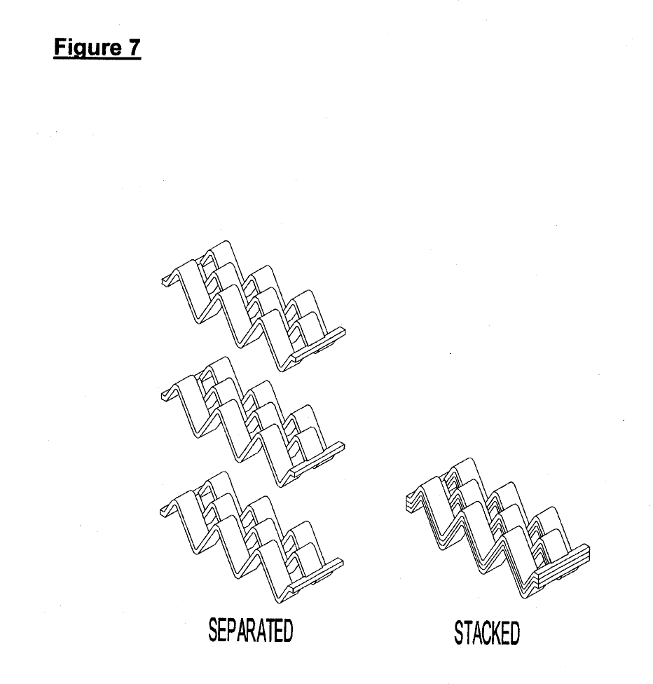

FIG. 7 depicts biodegradable stackable braces of this invention that can be used in packaging for void fill. The product is referred to as a “brace”, because it is designed to fill voids in packaging spaces by bracing against the item being shipped, a wall of the shipping container, other braces, or other objects in the container. The brace has “corrugated” sections, which means sections in which a strip of pulp and starch board regularly undulates or folds above and below the median plane of the brace. The brace has a plurality two or more corrugated sections situated side by side (three such corrugated sections are shown in each brace in the figure). The corrugations alternate in the sense that where one strip is folded generally upwards, the adjacent strips on either side are folded generally downwards. The brace is “stackable” in the sense that all the braces in a set have essentially the same pattern of folds or undulations, allowing them to sit atop one another in a way that minimizes the volume occupied by the set, but only when they are stacked in this fashion.

The undulating strips are cross-linked in some fashion to maintain them as a single unit. In FIG. 7, the strips are cross-linked at each end. Alternatively or in addition, they can be cross-linked at the points where the alternating strips cross. The cross-links can be put in place at the time the strips are generated and folded, or at a later time.

A stackable brace can be formed by drawing a slurry of fiber and starch into a two-part mold, where the two parts are complementary. This can be done by having a vacuum pull through one or preferably both parts of the mold as it passes through a bath of pulp and starch in water, thereby gathering a coating onto each half. The two parts are then compressed together, leaving enough space for the brace. Water is then withdrawn from the slurry in the mold by way of a vacuum, and the two parts of the mold are then separated to remove the brace.

An alternative manufacturing process is to make a sheet of pulp and starch by squeezing a slurry of both ingredients through a series of rollers. See Canadian patent disclosure 2,638,232. The sheet is cut into the desired number of corrugation rows, and folded into the final shape while the sheet is still malleable. Final drying occurs after the braces have been molded into the desired shape.

### Uses

The bubble-shaped wrap of this invention can be placed into service in the same manner as conventional bubble wrap. Items that are fragile or awkwardly shaped are wrapped in one or more layers of the wrap of this invention, and then placed in a container suitable for shipping. Also contemplated are combined packaging materials that comprise an outer container (such as an envelope or box) lined with bubble wrap.

Once an item has been wrapped for shipment and placed in a shipping container, one or more stackable braces of this invention can be used to fill any void spaces left between the wrapped item and the sides and/or the top of the container. Since the braces are made of pulp and starch, they are easily cut if needed to adjust the size to smaller spaces. A particular benefit of the braces of this invention is that they can be stacked tightly for distribution and storage before use as a void fill, by aligning the corrugations to correspond with each other, as shown in the “stacked” arrangement of FIG. 7. They can then be used singly or in combination to fill voids in a shipping container. By packing the braces so that the corrugations no longer align, each brace will occupy most of the volume defined by the tops and bottoms of its undulating corrugations. Unlike packing peanuts or particles which occupy essentially the same volume in storage or in use, the braces of this invention are stored in a compact aligned form, but used for void fill in unaligned form, thus considerably expanding the volume occupied.

The materials of this invention are designed to be “biodegradable”, which means they readily degrade when exposed to a natural environment out-of-doors: particularly water. The water will soon remove the starch, leaving the fiber in a non-compacted form. This can occur within a few days or weeks of water exposure. When the fiber is made of cellulose, it is also a natural product, essentially the same as the cellulose made by plants, and degradable by the same process. Since voids are created by loss of the salt, degradation is rapid. The bubble components of the bubble shaped wrap may disappear into non-visible particulates in as little as one major precipitation event, usually within a month or less. The paper backing may not disappear quite as rapidly, but is biodegradable in a natural environment. The user is cautioned to ensure compatibility at the site where the material is disposed of by checking local regulations and starting with a small test sample, in case there are plants, animals, or other environmental features near by with a special sensitivity to any of the ingredients or byproducts of the degradation.

The materials described in this disclosure can be effectively modified by routine optimization without departing from the spirit of the invention embodied in the claims that follow.

1-18. (canceled)

19. A biodegradable protective wrap for use in packaging, comprising a plurality of domed structures consisting essentially of cellulose fiber and starch, adhered to a backing

20. The protective wrap of claim 19, wherein the cellulose fiber is obtained from pulp made from recycled paper waste.

21. The protective wrap of claim 19, wherein the backing is paper.

22. The protective wrap of claim 19, wherein the domed structures are adhered to the backing by starch-based glue.

23. The protective wrap of claim 19, wherein the domed structures are square shaped, having a circular indentation on each side.

24. The protective wrap of claim 19, wherein the domed structures are round and have five solid supports supporting each dome.

25. A method for producing the protective wrap of claim 19, comprising:
drawing a suspension of pulp and starch in water into a mold shaped according to the outer surface of said domed structures;
withdrawing water from the suspension to dry the while in the mold;
expelling domed structures from pulp and starch dried in the mold; and
gluing the expelled domed structures onto a paper backing

26. The wrap of claim 19 for use in a method for protecting an item from possible damage during shipment, wherein the item is wrapped in the protective wrap.

27. The wrap of claim 19 for use in a method for shipping an item in a manner that decreases risk of damage to the item, wherein the item is shipped in the protective wrap.

28. The wrap of claim 19 wherein the wrap is disposable by placing it where it will be substantially exposed to moisture.

29. A biodegradable stackable brace for use in packaging for void fill, comprising a plurality of cross-linked alternating corrugations, wherein said alternating corrugations consist essentially of cellulose fiber and starch.

30. The protective wrap of claim 29, wherein the cellulose fiber is obtained from pulp made from recycled paper waste.

31. A method for producing the biodegradable stackable brace of claim 29, comprising:
drawing a slurry of fiber and starch into a two-part mold;
compressing the two parts of the mold together;
withdrawing water from the slurry in the mold; and then
separating the two parts of the mold to remove the brace.

32. The brace of claim 29 for use in a method for protecting an item from possible damage during shipment, wherein the item is packaged in a shipping container in which the brace has been used to fill one or more spaces.

33. The brace of claim 29 for use in a method for shipping an item in a manner that decreases risk of damage to the item, wherein the item is shipped in a container in which the brace has been used to fill one or more spaces.

34. The biodegradable stackable brace of claim 29, wherein the brace is disposable by placing it where it will be substantially exposed to moisture.
